(19) United States
(12) Patent Application Publication
(10) Pub. No.: US 2019/0333408 A1
(43) Pub. Date: Oct. 31, 2019

(54) Method and System for Improving User Compliance for Surface-Applied Products

(71) Applicant: The Procter & Gamble Company, Cincinnati, OH (US)

(72) Inventors: Gloria Yu Hua CHENG, Singapore (SG); Teerawat VONGXAIBURANA, Singapore (SG)

(21) Appl. No.: 16/395,416

(22) Filed: Apr. 26, 2019

Related U.S. Application Data
(60) Provisional application No. 62/663,274, filed on Apr. 27, 2018.

(51) Int. Cl. G09B 19/00; A45D 44/00; A45D 34/04

(52) U.S. Cl. CPC G09B 19/0076; A45D 34/04; A45D 44/005

(57) ABSTRACT

Method of improving compliance with usage instructions for a surface-applied product including: detecting an application surface feature having an application surface; displaying the application surface feature and application surface to a user in real-time; aligning an applicator graphic with the applicator surface and displaying the applicator graphic with the application surface feature; and moving the applicator graphic in accordance with an applicator graphic movement sequence to perform a tutorial sequence.

### FIELD OF THE INVENTION

Systems and methods for improving compliance with and/or the performance of surface-applied products, including those applied to a user's face and skin.

### BACKGROUND OF THE INVENTION

Consumers of products to be applied to surfaces, such as skin care and beauty products to be applied to the skin or other body surfaces, are often unfamiliar with how to use the product to get the best or advertised results. This can lead the consumer to be frustrated due to over or under use of the product, improper application of the product and/or confusion as to the correct way to use the product. In turn, this can lead to reduced efficacy of the product and ultimately, reduced sales and ultimately a reduction in brand equity.

Many different methods and technologies have been used in an attempt to improve compliance and efficacy of consumer applied products. However, they often fail or are not consumer desired for one or more of the following reasons: the consumer is unwilling to spend the time needed to read lengthy instructions, the consumer does not want to travel to get help, the consumer does not want to ask another human for help, the directions for use are not easy to put into practice based on the instructions given, the instructions are so generic the potential population of users that they are difficult for the consumer to replicate on him or herself, or the user can't remember the appropriate steps to ensure proper application of the product. Although the use of printed, life-like graphics and/or video tutorials can help, they still often fail to provide the needed information to the consumer at the right time and in a way that the consumer can quickly understand, execute and remember the proper techniques for effective application.

Therefore, it would be desirable to provide users with a cost effective, intuitive, customized, easy-to-use system and/or method for improving a consumer's understanding of the intended use of a product and/or how the product is effectively applied. The present invention combines the use of augmented reality and recognition technology to create real-time application tutorials that are intuitive and effective. This unique combination has been shown to provide a surprising and unexpected benefit over prior systems and methods.

### SUMMARY OF THE INVENTION

A system and method for improving compliance with usage instructions for a surface-applied product, the method including the steps of: detecting an application surface feature having an application surface; displaying the application surface feature and application surface to a user in real-time; aligning an applicator graphic with the applicator surface and displaying the applicator graphic with the application surface feature; and moving the applicator graphic in accordance with an applicator graphic movement sequence to perform a tutorial sequence.

### BRIEF DESCRIPTION OF THE DRAWINGS

FIGS. 1A-1I are a simplified flow chart of an example of the present method.

FIGS. 2A-2D depict exemplary graphic images showing how certain steps of the present method may be displayed to the user.

FIGS. 3A-3D depict exemplary graphic images showing how certain steps of the present method may be displayed to the user.

### DETAILED DESCRIPTION OF THE INVENTION

While the specification concludes with claims which particularly point out and distinctly claim the invention, it is believed the present invention will be better understood from the following description.

The present invention may comprise the elements and limitations described herein, as well any of the additional or optional steps, components, or limitations suitable for use with the invention, whether specifically described herein or otherwise known to those of skill in the art.

As used herein, the term “augmented reality” or “AR” refers to technology that superimposes a computer-generated image on a user's view of the real world, thus providing a composite view of the real world and a computer-generated graphic.

As used herein, the term “compliance” refers to the situation where a user of a product closely follows the directions for using and applying a product.

As used herein, the term “noncompliance” refers to the situation where a user of a product does not follow one or more of the usage or application instructions of the product.

As used herein, the term “real-time” refers to the actual current time that an event is happening plus a small amount of additional time required to input and process data from the event and to provide feedback to a user. For example, a real-time image of a user may be displayed on the screen of a computer, or mobile computing device such as a phone or tablet at the same time the user is inputting the image information via, for example, the device's camera, plus the few milliseconds it may take for the mobile device to process the image and display it on the device's screen.

The methods and processes of the present invention address several limitations related to know methods for educating consumers about how to apply products to surfaces. In addition, the methods and processes of the present invention help to improve the user's compliance with use instructions. As such, the methods and processes of the present invention can help reduce product waste while improving product efficacy, consumer confidence in the product and ultimately sales of the product.

Specifically, the methods and processes of the present invention provide consumers with cost effective, intuitive, customized, easy-to-use systems and/or methods for improving their understanding of the intended use of a product and/or how the product is effectively applied. The present invention combines the use of augmented reality and recognition technology to create real-time application tutorials that are intuitive and effective. This unique combination has been shown to provide a surprising and unexpected benefit over prior systems and methods for educating consumers of products applied to surfaces.

Although not limited thereto, one type of consumer that is especially benefitted by the processes and methods of the present invention is a consumer of products to be applied to surfaces of the body, such as, for example, the skin, hair and/or nails. Non-limiting examples of products that may be applied to the body that may benefit from the use of the systems and methods of the present invention are cosmetics, skin care products, lotions, medicines, balms, cleaning products, sunscreen products, deodorants, perfumes, pigments, moisturizers, and the like and/or combinations thereof.

Often, products to be applied to the users' body surfaces are not familiar to the consumer and have unique instructions, which, if not followed or only partially followed (i.e. “noncompliance”), can lead to undesired results. For example, under or over use of the product and/or misapplication of the product in terms of location, application procedure, application time and/or applicator used can lead the consumer to become frustrated, confused and/or unhappy with the product. It can also lead to reduced efficacy of the product and/or performance that is not consistent with the advertised or indicated benefits or results. Additionally, in certain circumstances, consumer noncompliance can result in product being wasted, which can be expensive for the consumer, and/or even harm to the consumer due to the under, over or misapplication of the product.

Manufacturers and sellers of consumer-applied products as well as advisors (e.g. doctors, beauty consultants, store representatives, and product experts) for consumers using such products have attempted improve the consumer experience and compliance by a variety of means over the years, including written instructions, audio, graphics, video, in-person demonstrations, and even augmented reality. However, the methods used to date often fail or are not consumer desired for one or more of the following reasons: the consumer is unwilling to spend the time needed to read lengthy instructions, the consumer does not want to travel to get help, the consumer does not want to ask another human for help, the directions for use are not easy to put into practice based on the instructions given, the instructions are so generic the potential population of users that they are difficult for the consumer to replicate on him or herself, or the user can't remember the appropriate steps to ensure proper application of the product. Further, known methods for instructing users often fail to provide the needed information to the consumer at the right time and in a way that the consumer can quickly understand, execute and remember the proper techniques for effective application.

It has been surprisingly found that consumer compliance with respect to application and use instructions for surface-applied products, can be improved significantly using the processes and methods of the present invention. Specifically, it has been found that the use of real-time, augmented reality showing the actual surface to which the product is to be applied as well as a computer-generated graphic of the application device to be used is preferred by consumers, provides for better compliance with the use and application instructions than, is easier for the consumer to implement and remember, and provides overall more consistent and better results than other methods that tend to be more in line with the expected, advertised or indicated results for the product when used as directed.

For example, it has been unexpectedly found that for application of skin care products, such as lotions, creams, masks, balms, sunscreens, etc. and the like, the use of real-time, augmented reality to display the surface onto which the product is to be applied along with animation of the implement to be used to apply the product and how it is properly applied will result in significantly improved application compliance, satisfaction with the product, and improved efficacy of the product as compared to other user instruction methods.

Examples of systems and methods in accordance with the present invention are described hereinbelow. Although the examples are specifically directed to skin-applied products such as, for example, cosmetics, lotions, medicaments, sunscreens, balms, cleaning products, deodorants, perfumes, pigments, moisturizers, and the like, the invention is not limited to such applications and should be understood to relate to any and all surface-applied products unless expressly described herein as limited to that particular embodiment.

The system and method of the present invention are described herein having certain input and output devices. It should be understood that such input and output devices are only examples of devices that can be used to carry out the method. It is fully contemplated that other suitable input and output devices can be used with the methods and systems of the present invention and the disclosure herein should not be considered to be limiting in terms of any such devices. In addition, as described herein, the method and/or system of the invention may include or involve certain software and executable instructions for computing devices. As with the input and output devices for the present invention, the disclosure of any specific software or computer instructions should not be limiting in terms of the specific language or format as it is fully expected that different software and computer instructions can lead to the same or significantly the same results. As such, the invention should be considered to encompass all suitable software, code and computer executable instructions that enable the devices used in the methods and processes to provide the necessary inputs, calculation, transformations and outputs. Finally, the specific graphics shown in the figures and described herein are merely examples of graphics that are suitable for the methods and processes of the claimed invention. It is fully contemplated that specific graphics for any particular use will be created, chosen and/or customized for the desired use.

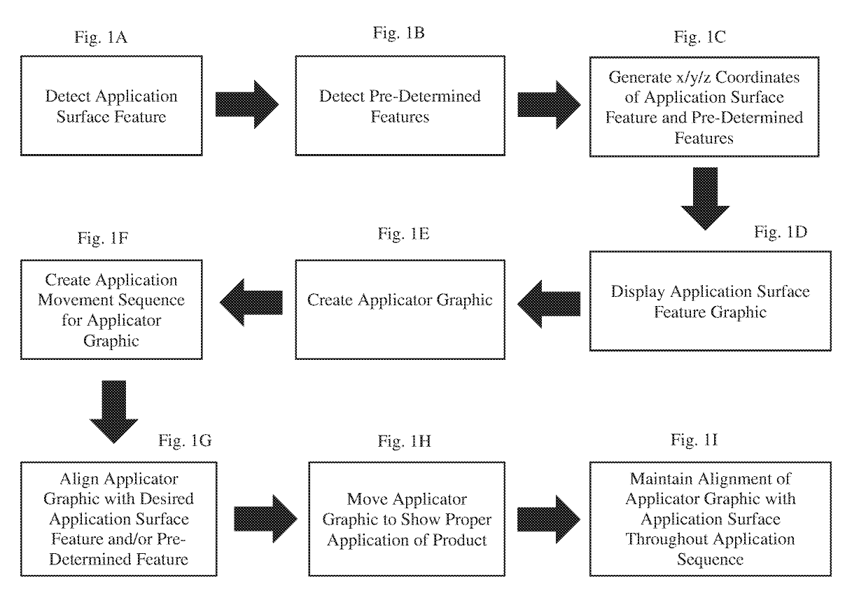

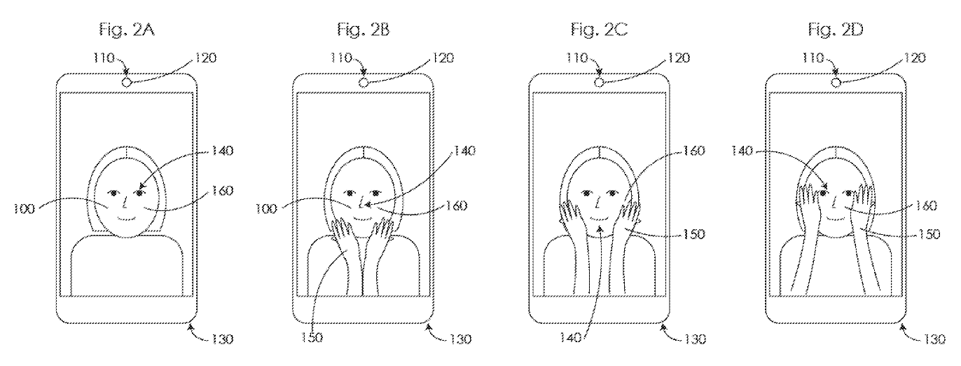

FIGS. 1A-1I form a simplified flowchart of a process and method of the present invention. Specifically, the flowchart shows the steps included in the method of improving compliance with use instructions for a skin care product, such as a face lotion. The steps shown are intended to illustrate the general flow of the steps of the method. However, the order of the steps is not critical and it should be understood that additional steps can be included in the method before, between or after any of the steps shown. Additionally, the steps shown in FIGS. 1A-1I are exemplary in that some or all may be used in embodiments of the present invention, but there is no requirement that any or all of the specific steps shown are required in all embodiments and it is contemplated that some of the steps can be combined, separated into more than one step and/or changed and still be considered within the present invention. The description of the steps represented by FIGS. 1A-1I refers to features that, for reference purposes, are illustrated and called out numerically in FIGS. 2A-D and 3A-D.

FIG. 1A represents the step of detecting an application surface feature. An “application surface feature” as used herein refers to a surface or a portion of a surface to which a product will be applied. For example, as shown in FIG. 2A, the application surface feature 100 may be a portion of a user's skin, such as a face, portion of a face, or other part of the body. The application surface feature 100 is detected by an image input device 110, such as, for example a camera 120 shown in FIGS. 2A-2D. The image input device 110 allows the user to input a real-time image of the application surface feature 100, such as the user's face, into a computing device 130, such as a computer, mobile phone, tablet or the like for additional processing. The computing device 130 includes or is capable of executing software, code or other instructions to allow it to detect, display and/or transform the image.

FIG. 1B represents the step of detecting one or more pre-determined feature characteristics 140 of the application surface feature 100. For example, the computing device 130 may detect the lips, nose, eyes and eye brows of the user if the application surface feature 100 is the user's face. This step allows the computing device 130 to determine the location of the application surface feature 100 and the relative location of the different pre-determined features 140 that can be used to “track” the features and/or locate how and/or where output graphics may be displayed.

FIG. 1C represents the step of generating x, y and z coordinates of the application surface feature 100 and any pre-determined feature characteristics 140. This step, allows the computing device 130 to determine the relative location of the different pre-determined features 140 and can be used to “track” application surface feature 100 and/or the pre-determined features to locate how and/or where output graphics should be displayed.

FIG. 1D represents display of the application surface feature 100. FIGS. 2A-D and 3A-D show examples of application surface features 100 displayed on a mobile device. The figures only show selected, representative graphics at certain times during the process. Under typical use scenarios, the method and process of the present invention will display the application surface feature 100 in real-time, and once the instruction demonstration is started, the application surface feature 100 will be continuously, or nearly continuously displayed throughout the instruction sequence.

The graphics shown in FIGS. 2A-D and 3A-D are representative of those that may be displayed on a mobile device such as a mobile phone or tablet computer. However, the present invention contemplates display of the relevant graphics on any one or more suitable displays or in any suitable way that is viewable by the user, including, but not limited to monitors, mobile computing devices, television screens, projected images, holographic images, mirrors, smart mirrors, any other display devices of any suitable size for the desire use, and combinations thereof.

FIG. 1E represents creation of the applicator graphic 150. The applicator graphic 150 is an important feature of the invention as it provides the user detailed information about how to use the product without the need for additional information, such as words or sounds. The applicator graphic 150 can be displayed along with the image of the application surface feature 100 (e.g. a user's face) to show the user the specific application device that is to be used and how it is to be used. The graphic itself is animated or computer-generated. That is, it is not merely a reflection or display of a portion of the user's body or an applicator, but rather is at least partially created, moved and/or manipulated by a computing device. The applicator graphic 150 can be a graphical copy of an actual body part or device (e.g. electronic photo image) or can be a graphical representation of the specific applicator device. In any case, the applicator graphic 150 should be recognizable to the user as it is the combination of the display of the applicator graphic 150 over the application surface feature 100 and the movement of the applicator graphic 150 that makes the method intuitive to the user and allows for significantly increased compliance with the usage indications.

FIG. 1F represents the step of creating a movement sequence for an applicator graphic 150. As used herein, an “applicator graphic” is a computer-generated graphic that represents the applicator to be used to apply the product to the application surface 160. The application surface 160 is that portion of the application surface feature 100 to which product is to be applied. For example, as shown in FIGS. 2A-2C, the application surface 160 is the cheek portion of the user's face. The applicator can be any suitable applicator or applicators for the product, including, but not limited to, hands, swabs, cloth, wipes, gloves, spatulas, brushes, sponge, pens, wands, or any other device suitable for application of the product. The applicator graphic 150 will generally be the preferred or one of the preferred or approved applicators for the product as determined by the party providing the instructions for use, such as, for example, the manufacturer, distributer, advisor, or seller.

The movement sequence discussed herein is a pre-determined sequence of movements that the user should follow to properly apply the product to the application surface 160. The movement sequence will typically be pre-programmed and available to and/or stored in the computing device 130 prior to starting the method. However, it is contemplated that the movement sequence could be generated in real-time by the computing device 130 and/or provided to the computing device 130 before or as the method is being performed. Additionally, the computing device 130 may include or obtain two or more different movement sequences that can be used for different application of different products, use of different applicators or that allow the user or seller to customize the movement sequence based on pre-identified or input characteristics or conditions based on characteristics of the product, the user or a desired performance characteristic of the product. For example, the movement sequence might be different for use of one's hands as an applicator versus when a brush or sponge is used. Further, the movement sequence might be different to accommodate for different bone structure under the user's skin, the color or the skin or other pre-determined attributes. Additionally or alternatively, the user, seller or advisor could input into the device a certain “mode” or use preference that will change how the product is to be most effectively applied.

FIG. 1G represents the step of aligning the applicator graphic 150 with the appropriate portion of the application surface feature 100 such that the applicator graphic 150 movement sequence properly represents how the applicator is to be moved with reference to the application surface 160 to ensure appropriate application of the product.

FIGS. 1H and 1I represents moving the applicator graphic 150 across the displayed application surface feature 100 so as to depict proper application of the product to the application surface 160 and maintaining alignment of the applicator graphic 150 to the application surface 100 throughout the instruction sequence. Alignment of the applicator graphic 150 and the application surface 160 of the application surface feature 100 in real-time provides the user with an augmented reality experience that appears to show the user applying the product to the application surface 160. For especially effective augmented reality, the applicator graphic 150 should be able to track with the application surface feature 100 even if it moves during the instruction sequence.

FIGS. 2A-2D show an example of the present invention where a user is directed how to apply a facial cream using her hands. FIG. 2A shows how an application surface feature 100, in this case, a user's face, might be displayed on a mobile computing device, such as a mobile phone. FIG. 2B shows how the application graphic 150 may be displayed on the device in combination with the display of the application surface feature 100. FIGS. 2C and 2D show how the applicator device 150 (hands) move in a pre-determined sequence across the application surface feature 100 to show the user how to properly apply the product to the application surface 160.

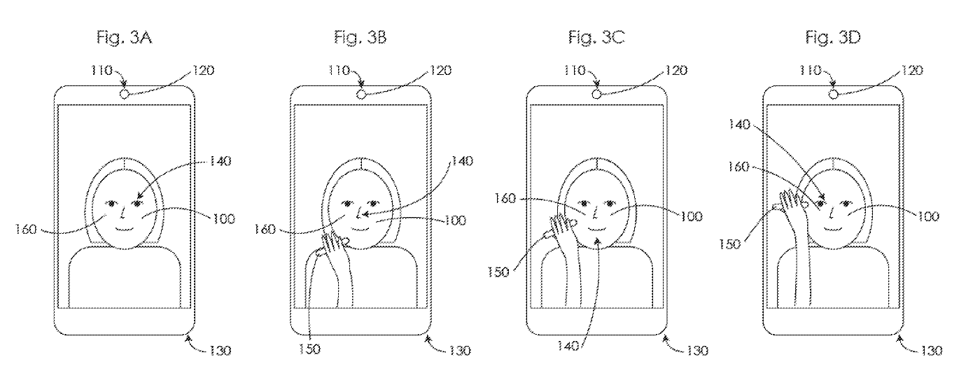

FIGS. 3A-3D are similar to FIGS. 2A-2D, except that the applicator depicted by the applicator graphic 150 is a device, such as a “wand” rather than the user's hands.

As shown below, the unique combination of displaying the application surface feature 100, the applicator graphic 150 and the animated movement of the applicator graphic 150 across the appropriate portion of the application surface feature 100 to direct the use what applicator should be used in addition to how the applicator should be used has been surprising found to provide not only significantly improved compliance with use instructions, but also improved efficacy of the product and improved overall satisfaction with the product.

### Data

Several different types of testing were done to determine the effectiveness of the method of the present invention and consumers' preference for use instructions when exposed to a new product requiring application of the product to a surface.

First, six panelists were exposed to different known methods for directing users how to apply a product to a surface. Specifically, panelists were provided instructions by: a beauty counsellor in person, watching a how-to video, and 2D pictorials. Panelists were then exposed to the method of the present invention including real-time augmented reality with applicator graphics. All panelists preferred the method of the present invention over the other tutorial methods to which they were otherwise exposed.

Second, ten female panelists were shown two similar tutorials including real-time augmented reality as described herein. However, the first tutorial included an applicator graphic (computer-generated hands) and the second did not. Rather, the second version of tutorial only showed the user where to apply the product by highlighting the correct portions of the user's face to which the product should be applied. All panelists preferred the version of the tutorial that included the applicator graphic. Further, all panelists found the version of the tutorial including the applicator graphic to be more effective for delivering the use instructions for the product versus the version of the tutorial without the applicator graphic. The tabulated results of the research are shown below in Table 1.

TABLE 1

| | | Q2. Rating in effective | Q3. Rating in effective |
|---|---|---|---|
| | | delivery of instructions | delivery of instructions |
| | Q1. Would you prefer | for applicator graphic | for tutorial without |
| | the tutorial with | tutorial. Scale of 5 (5 | applicator graphic. Scale |
| | applicator graphic or | being the highest and 1 | of 5 (5 being the highest |
| Panelist | without? | being the lowest) | and 1 being the lowest) |
| 1 | With applicator graphic | 5 | 3 |
| 2 | With applicator graphic | 5 | 3 |
| 3 | With applicator graphic | 4 | 3 |
| 4 | With applicator graphic | 4 | 3 |
| 5 | With applicator graphic | 5 | 2 |
| 6 | With applicator graphic | 4 | 2 |
| 7 | With applicator graphic | 4 | 2 |
| 8 | With applicator graphic | 5 | 3 |
| 9 | With applicator graphic | 5 | 3 |
| 10 | With applicator graphic | 5 | 3 |

Third, research was conducted with six panelists. All panelists were given SK-II™ RNA cream to use for one week. The first group of three panelists (the “control group”) were shown a video describing and depicting how to apply the cream. The second group of three panelists (the “test group”) were shown the same video as the control group, but then were asked to view a tutorial on a digital device (mobile phone) that included a real-time augmented reality tutorial including an applicator graphic superimposed over a real-time image of the user. After being provided the instructions, both groups were asked to use the product for one week and then return for an evaluation. All of the test group were rated compliant by the expert beauty consultant evaluating the panelists. Further, all of the panelists that were exposed to the real-time augmented reality instruction reported that they observed more improvement in their skin. All of the panelists of the control group were rated only partially compliant (i.e. noncompliant) by the expert beauty consultant evaluating the panelists. Results of the research are shown in Table 2, below.

TABLE 2

| | | Compliant |
|---|---|---|
| | | with use |
| Panelist | Group | instructions? |
| 1 | Control | No |
| 2 | Control | No |
| 3 | Control | No |
| 4 | Test | Yes |
| 5 | Test | Yes |
| 6 | Test | Yes |

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of improving compliance with usage instructions for a surface-applied product, comprising:
a) detecting an application surface feature having an application surface;
b) displaying the application surface feature and application surface to a user in real-time;
c) aligning an applicator graphic with the applicator surface and displaying the applicator graphic with the application surface feature; and
d) moving the applicator graphic in accordance with an applicator graphic movement sequence to perform a tutorial sequence.

2. The method of claim 1 additionally including detecting pre-determined features on the application surface feature.

3. The method of claim 1 additionally including generating x, y and z coordinates of the application surface feature and/or pre-determined features.

4. The method of claim 1 wherein the applicator graphic movement sequence is performed to instruct the user how to apply the product to the application surface.

5. The method of claim 1 additionally including creating or obtaining an applicator graphic.

6. The method of claim 1 additionally including and maintaining alignment of the applicator graphic with the application surface feature throughout the tutorial sequence.

7. The method of claim 1 wherein the product is a product applied to a surface of the human body.

8. The method of claim 1 wherein the product is a cosmetic, skin care product, lotion, medicine, balm, cleaning product, sunscreen product, deodorant, perfume, pigment, moisturizer, or a combination thereof.

9. The method of claim 1 wherein the application surface feature is a human face.

10. The method of claim 9 wherein the application surface is the skin on a portion of the human face.

11. The method of claim 1 wherein the applicator graphic is of a human hand or a hand-held application device.

12. The method of claim 11 wherein the applicator graphic includes a graphic of a cotton ball, swab, cloth, wipe, glove, spatulas, brush, sponge, pen, wand, or combinations thereof.

13. The method of claim 1 wherein the steps are performed using a device selected from the following: computer, mobile phone, and tablet computer.

14. The method of claim 1 wherein the user causes the device to perform the steps without the aid of a consultant.

15. The method of claim 1 wherein a consultant causes a computing device to perform the steps for the user.

16. The method of claim 1 wherein the movement sequence is based on a product characteristic, a characteristic of the user or a pre-determined product performance characteristic.

17. The method of claim 1 wherein the applicator graphic and application surface feature are displayed on one or more of the following: a monitor, a screen of a mobile computing device, a television screen, or a mirror.

18. A system for improving compliance with usage instructions for a surface-applied product, comprising:
a) a graphic input device configured to capture a graphic image;
b) a display; and
c) a programmable computer programmed to perform the following actions on the graphic image captured by the graphic input device:
i) detect an application surface feature having an application surface and pre-determined features on the application surface feature,
ii) generate x, y and z coordinates of the application surface feature and/or pre-determined features,
iii) create an applicator graphic,
iv) display the application surface feature and applicator graphic to a user on the display, wherein the applicator graphic is aligned with at least one of the applicator surface feature or the pre-determined features,
v) select an applicator graphic movement sequence to instruct a user how to apply the product to the application surface, and
vi) move the applicator graphic in accordance with the applicator graphic movement sequence to perform a tutorial sequence so as to maintain alignment of the applicator graphic with the application surface feature throughout at least a portion of the tutorial sequence.

19. The system of claim 18 wherein the applicator graphic is of a human hand or a hand-held application device.

20. The system of claim 19 wherein the applicator graphic includes a graphic of a cotton ball, swab, cloth, wipe, glove, spatulas, brush, sponge, pen, wand, or combinations thereof.
